(19) United States
(12) Patent Application Publication
(10) Pub. No.: US 2011/0234505 A1
(43) Pub. Date: Sep. 29, 2011

(54) TOUCH PANEL

(76) Inventors: Woon Chun Kim, Gyunggi-do (KR); Jong Yong Lee, Gyunggi-do (KR); Yong Soo Oh, Gyunggi-do (KR)

(21) Appl. No.: 12/825,225

(22) Filed: Jun. 28, 2010

(30) Foreign Application Priority Data
Mar. 26, 2010 (KR) 10-2010-0027516

(51) Int. Cl. G06F 3/041

(52) U.S. Cl. 345/173

(57) ABSTRACT

Disclosed herein is a touch panel 100 including: a transparent substrate 110 that includes an active region 120 and a connection region 130 provided at the edges of the active region 120, a transparent electrode 140 that is formed in the active region 120, a flexible printed cable 150 that includes a connection unit 160 formed corresponding to the connection region 130 and having one surface bonded to the connection region 130 and an extension unit 170 extended from the connection unit 160 and projected outward to the transparent substrate 110, a connection terminal 180 that is formed on one surface of the connection unit 160 so as to be connected to the transparent electrode 140, and wirings 190 that are formed on the flexible printed cable 150 so that the wirings 190 are extended from the connection terminal 180 to be collected at the extension unit 170.

### CROSS REFERENCE TO RELATED APPLICATION

This application claims the benefit of Korean Patent Application No. 10-2010-0027516, filed on Mar. 26, 2010, entitled “Touch Panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting the computers have also been developed, and personal computers, portable transmitters and other personal information processors execute processing of text and graphics using a variety of input devices such as a keyboard, a mouse and so on.

While the rapid advancement of the information-based society has been widening the use of computers more and more, there have been occurring the problems of it being difficult to efficiently operate products using only the keyboard and mouse as being currently responsible for the input device function. Thus, the demand for a device which is simple, does not malfunction, and has the capability to input easily is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used.

However, in the touch panel according to the prior art, a connection defect occurs in connecting wirings formed on a transparent substrate to a flexible printed cable (FPC). FIG. 1 is a perspective view of a touch panel according to the prior art. Problems of the prior art will be described with reference to FIG. 1.

As shown in FIG. 1, the touch panel 10 according to the prior art includes a transparent substrate 20, a transparent electrode 30 that is formed on the transparent substrate 20, wirings 40 that are extended from the transparent electrodes 30 to be collected at one end of the transparent substrate 20, and a controller 50 that is connected to the wirings 40 through a flexible printed cable 60.

Herein, the wiring 40 serves to transfer signals generated from the transparent electrode 30 to the flexible printed cable 60. However, the wiring 40 formed on the transparent substrate 20 has low electric conductivity. Further, since fine wirings cannot be formed on the transparent substrate 20, the interval between the wirings 40 becomes wide, such that the bazel width of the touch panel 10 becomes wide.

In addition, the flexible printed cable 60 serves to transfer the signals transferred from the wirings 40 to the controller 50. At this time, the flexible printed cable 60 should be securely connected to the wirings 40 in order to ensure the signal transfer reliability of the flexible printed cable 60. However, a connection portion A having a small area is structurally weak, such that the flexible printed cable 60 may become detached from the wirings 40 when a force of more than a predetermined strength is applied thereto. In addition, the connection portion A between the flexible printed cable 60 and the wirings 40 has a very high connection resistance.

### SUMMARY OF THE INVENTION

The present invention has been made in an effort to provide a touch panel that uses and directly connects a flexible printed cable including a connection terminal and a wiring to a transparent electrode to enable to improve electric conductivity of the wirings and finely form the wirings.

A touch panel according to a first preferred embodiment of the present invention includes: a transparent substrate that includes an active region and a connection region provided at the edges of the active region; transparent electrodes that are formed in the active region; a flexible printed cable that includes a connection unit formed corresponding to the connection region and having one surface bonded to the connection region and an extension unit extended from the connection unit and projected outward to the transparent substrate; connection terminals that are formed on one surface of the connection unit so as to be connected to the transparent electrodes; and wirings that are formed on the flexible printed cable so that the wirings are extended from the connection terminals to be collected at the extension unit.

Herein, the active region is formed in a rectangular shape and the connection unit is formed so as to correspond to the connection region provided at four edges of the active region.

Further, the active region is formed in a rectangular shape and the connection unit is formed so as to correspond to the connection region provided at three edges of the active region.

Further, the active region is formed in a rectangular shape and the connection unit is formed so as to correspond to the connection region provided at two continuous edges of the active region.

Further, the active region is formed in a rectangular shape and the connection unit is formed so as to correspond to the connection region provided at one edge of the active region.

Further, one or two extension unit is provided.

Further, the connection terminal is connected to the transparent electrode using an anisotropic conductive adhesive or an anisotropic conductive film.

Further, the transparent electrode is made of a conductive polymer.

A touch panel according to a second preferred embodiment of the present invention includes: first and second transparent substrates that include an active region and a connection region provided at the edges of the active region; first transparent electrodes that are formed in the active region of the first transparent substrate; second transparent electrodes that are formed in the active region of the second transparent substrate; a flexible printed cable that includes a connection unit formed corresponding to the connection region and having one surface bonded to the connection region of the first transparent substrate and the other surface bonded to the connection region of the second transparent substrate and an extension unit extended from the connection unit and projected outward to the first and second transparent substrates; first connection terminals that are formed on one surface of the connection unit so as to be connected to the first transparent electrodes; second connection terminals that are formed on the other surface of the connection unit so as to be connected to the second transparent electrodes; first wirings that are formed on the flexible printed cable so that the first wirings are extended from the first connection terminal to be collected at the extension unit; and second wirings that are formed on the flexible printed cable so that the second wirings are extended from the second connection terminal to be collected at the extension unit.

Herein, the active region is formed in a rectangular shape and the connection unit is formed so as to correspond to the connection region provided at four edges of the active region.

Further, the active region is formed in a rectangular shape and the connection unit is formed so as to correspond to the connection region provided at three edges of the active region.

Further, the active region is formed in a rectangular shape and the connection unit is formed so as to correspond to the connection region provided at two continuous edges of the active region.

Further, the active region is formed in a rectangular shape and the connection unit is formed so as to correspond to the connection region provided at one edge of the active region.

Further, one or two extension unit is provided.

Further, the first connection terminal is connected to the first transparent electrode using an anisotropic conductive adhesive or an anisotropic conductive film and the second connection terminal is connected to the second transparent electrode using an anisotropic conductive adhesive or an anisotropic conductive film.

Further, the first transparent electrode or the second transparent electrode is made of a conductive polymer.

### BRIEF DESCRIPTION OF THE DRAWINGS

FIG. 1 is a perspective view of a touch panel according to the prior art;

FIG. 2 is an exploded perspective view of a touch panel according to a first preferred embodiment of the present invention;

FIG. 3 is a perspective view of a touch panel according to a first preferred embodiment of the present invention;

FIGS. 4 to 8 are plan views of the flexible printed cable of FIG. 2;

FIG. 9 is an exploded perspective view of a touch panel according to a second preferred embodiment of the present invention;

FIG. 10 is a perspective view of a touch panel according to a second preferred embodiment of the present invention;

FIG. 11A is a plan view of the flexible printed cable of FIG. 9; and

FIG. 11B is a bottom view of the flexible printed cable of FIG. 9.

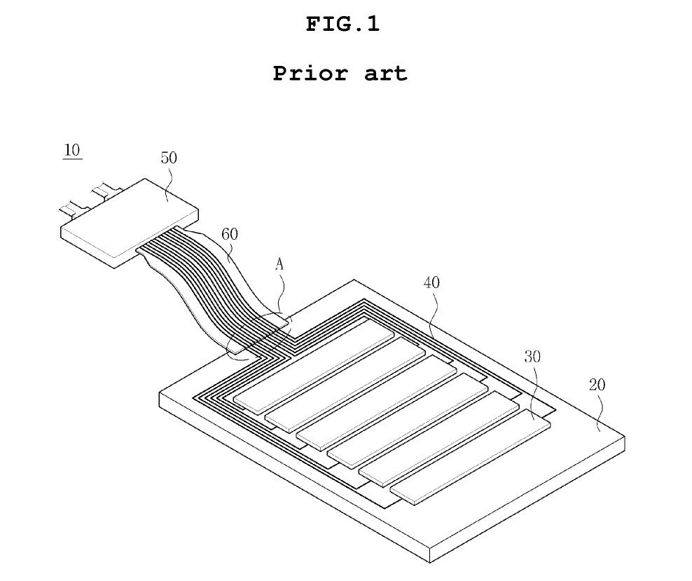

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

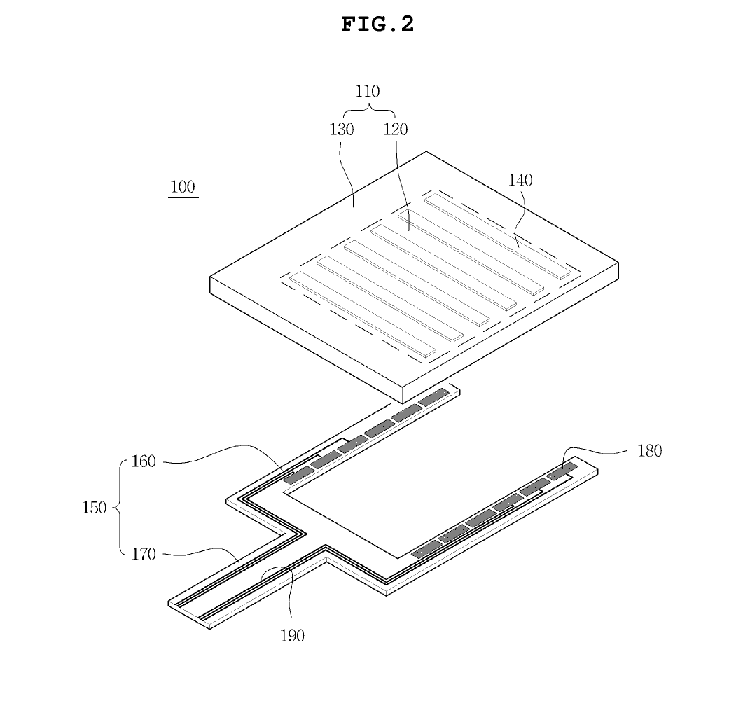

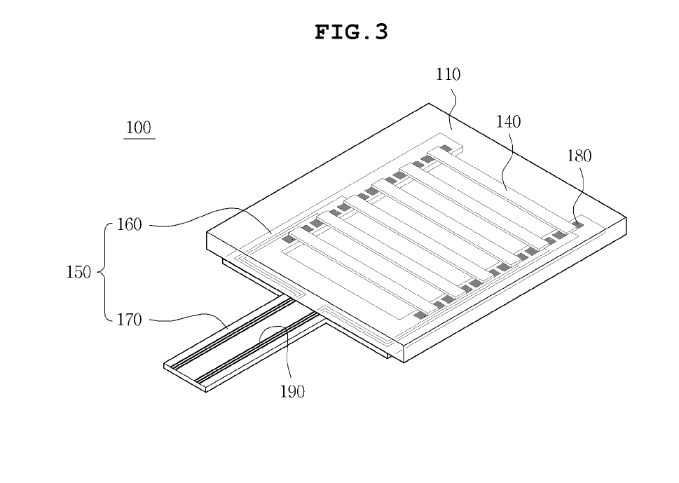

FIG. 2 is an exploded perspective view of a touch panel according to a first preferred embodiment of the present invention, and FIG. 3 is a perspective view of a touch panel according to a first preferred embodiment of the present invention.

As shown in FIGS. 2 and 3, the touch panel 100 according to the present embodiment includes a transparent substrate 110 that includes an active region 120 and a connection region 130 provided at the edges of the active region 120, transparent electrodes 140 that are formed in the active region 120, a flexible printed cable 150 that includes a connection unit 160 formed corresponding to the connection region 130 and having one surface bonded to the connection region 130 and an extension unit 170 extended from the connection unit 160 and projected outward to the transparent substrate 110, connection terminals 180 that are formed on one surface of the connection unit 160 so as to be connected to the transparent electrodes 140, and wirings 190 that are formed on the flexible printed cable 150 so that the wirings 190 are extended from the connection terminals 180 to be collected at the extension unit 170.

The transparent substrate 110 includes the active region 120 and the connection region 130. The active region 120, which is a portion in which the transparent electrodes 140 are installed in order to sense a user touch, is formed in the center of the transparent substrate 110. The connection region 130, which is a portion to which the flexible printed cable 150 to be connected to the transparent electrodes 140 is bonded, is provided at the edges of the active region 120. The material of the transparent substrate 110 is not particularly limited, and may include polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass and so on.

The transparent electrode 140 serves to generate signals when a user touches it and allows a controller (not shown) to recognize touched coordinates. The transparent electrode 140 is formed in the active region 120 of the transparent substrate 110. Herein, the material of the transparent electrode 140 is not particularly limited, but may include a conductive polymer having excellent flexibility and a simple coating process or indium tin oxide (ITO) generally used. At this time, the conductive polymer includes poly-3,4-ethylenedioxythiophene/polystyrenesulfonate (PEDOT/PSS), polyaniline, polyacetylene, polyphenylenevinylene, or the like. Meanwhile, although the transparent electrode 140 is shown in the shape of a bar in the drawings, it is not limited thereto but may be formed in any type of patterns publicly known in the art to which the present invention pertains, such as a triangular shape, a hexagonal shape, or the like.

The flexible printed cable 150 includes the connection unit 160 that is formed corresponding to the connection region 130 of the transparent substrate 110 and is bonded to the connection region 130, and the extension unit 170 that is extended from the connection unit 160 and is projected outward to the transparent substrate 110. Herein, the connection terminals 180 are formed on one surface of the connection unit 160 such that when one surface of the connection unit 160 is bonded to the connection region 130, the connection terminals 180 are connected to the transparent electrode 140. Further, the wirings 190 extended from the connection terminals 180 to be collected at the extension unit 170 are provided on the flexible printed cable 150, such that the signals generated from the transparent electrodes 140 are transferred to the wirings 190 through the connection terminals 180.

The flexible printed cable 150 according to the present embodiment includes not only the extension unit 170 corresponding to the flexible printed cable according to the prior art but also the connection unit 160 bonded to the connection region 130 of the transparent substrate 110. Therefore, a contact area between the flexible printed cable 150 and the transparent substrate 110 becomes wide, thereby making it possible to secure structural stability of the flexible printed cable 150.

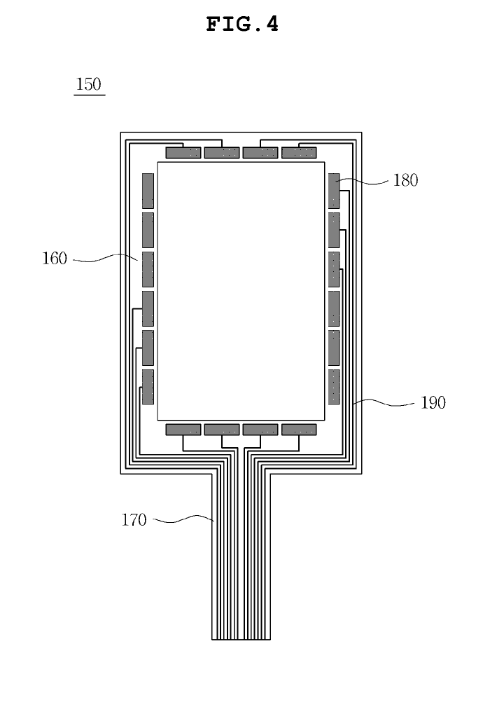

Meanwhile, FIGS. 4 to 8 are plan views of the flexible printed cable of FIG. 2;

As shown in FIGS. 4 to 7, the connection unit 160 of the flexible printed cable 150 may be formed in various shapes.

For example, when the active region 120 is formed in a rectangular shape, the to connection units 160 may be formed in a ‘ [symbol] ’ shape so as to correspond to the connection region 130 provided at four edges of the active region 120 (see FIG. 4). In this case, it is possible to prevent the connection units 160 from being widened or narrowed, thereby making it possible to exactly match the connection terminals 180 to the transparent electrodes 140.

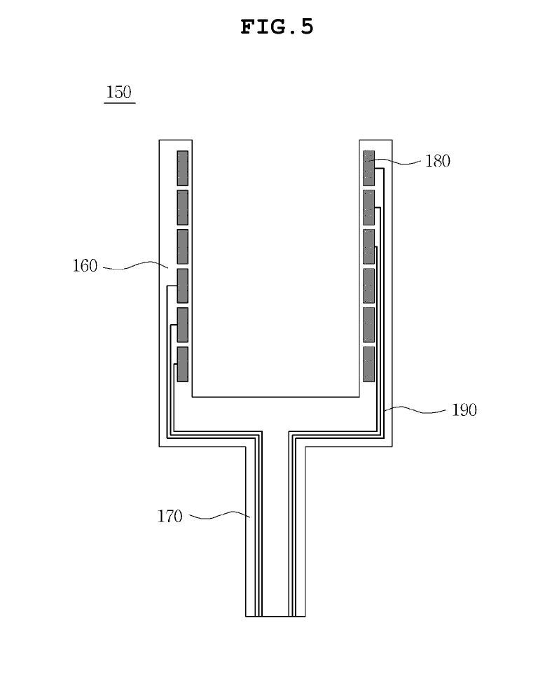

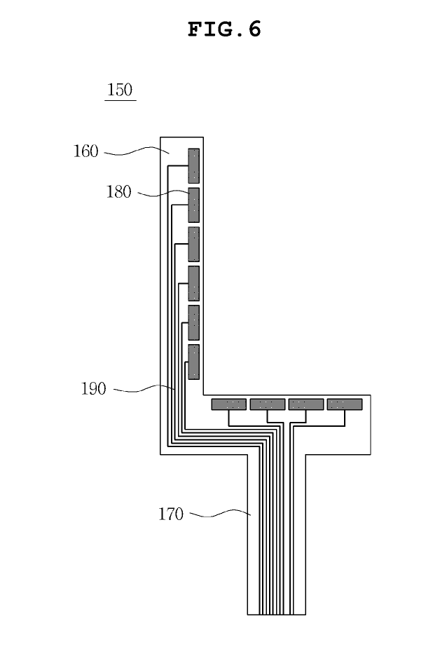

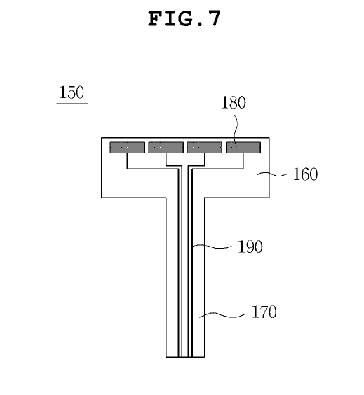

Alternatively, the connection units 160 may be formed in a ‘ [symbol] ’ shape so as to correspond to the connection region 130 provided at three edges of the active region 120 (see FIG. 5). The connection units 160 may be formed in a ‘ [symbol] ’ shape so as to correspond to the connection region 130 provided at two continuous edges of the active region (see FIG. 6). The connection units 160 may be formed in a ‘ [symbol] ’ shape so as to correspond to the connection region 130 provided at one edge of the active region (see FIG. 7). In this case, the area of the connection unit 160 becomes relatively narrower, thereby making it possible to maximally widen the width of the active region 120 in the touch panel 100 having the same size. The shape of the connection unit 160 is shown by way of example only and therefore, may be varied depending on the shape of the active region 120, the pattern of the transparent electrode 140, or the like.

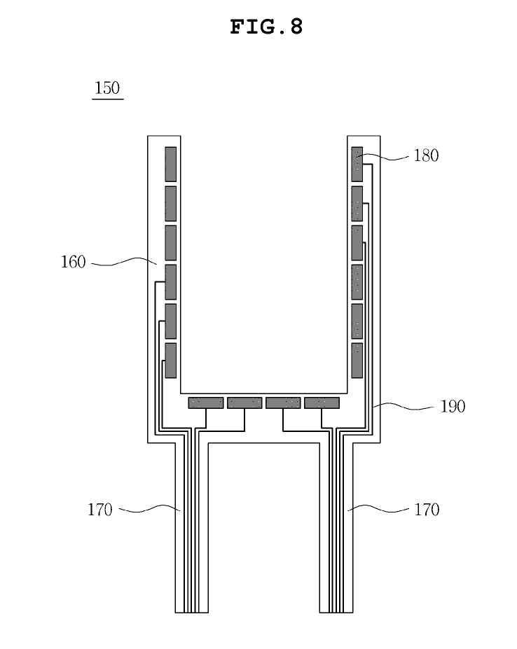

In addition, the extension unit 170 of the flexible printed cable 150 is projected outward to the transparent substrate 110 and the wirings 190 are collected at the extension unit 170, such that when the extension unit 170 is finally connected to the controller, the signals generated from the transparent electrode 140 are transferred in the sequence, that is, the connection terminal 180→the wirings 190→the controller (see FIG. 3). Meanwhile, although one extension unit 170 may be generally provided (see FIGS. 3 to 7), two extension units 170 may be provided as shown in FIG. 8 and three or more extension units 170 may also be provided, as needed.

As described above, the connection terminals 180 are formed on one surface of the connection unit 160 to be connected to the transparent electrodes 140 (see FIG. 3). Herein, the connection terminal 180 may be connected to the transparent electrode 140 using an anisotropic conductive adhesive (ACA) or an anisotropic conductive film (ACF). The anisotropic conductive adhesive (ACA) and the anisotropic conductive film contain fine conductive balls, thereby making it possible to reduce contact resistance between the transparent electrodes 140 and the connection terminals 180.

The wirings 190 are formed on the flexible printed cable 150 rather than on the transparent substrate 110, different from the prior art. Therefore, the wirings 190 may be made of metal, thereby making it possible to improve electric conductivity of the wirings 190. In addition, the wirings 190 can be finely formed to minimize the thickness of the connection unit 160 of the flexible printed cable 150, thereby making it possible to widen the width of the active region 120.

The touch panel 100 according to the present embodiment has a structure in which the transparent electrode 140 has a one-layer, such that it may be used as a self capacitive type touch panel. Further, two touch panels 100 according to the present embodiment are bonded to each other using a double-sided adhesive so that their transparent electrodes 140 face each other, such that they may be used as a mutual capacitive type touch panel having a two-layer structure or a resistive type touch panel.

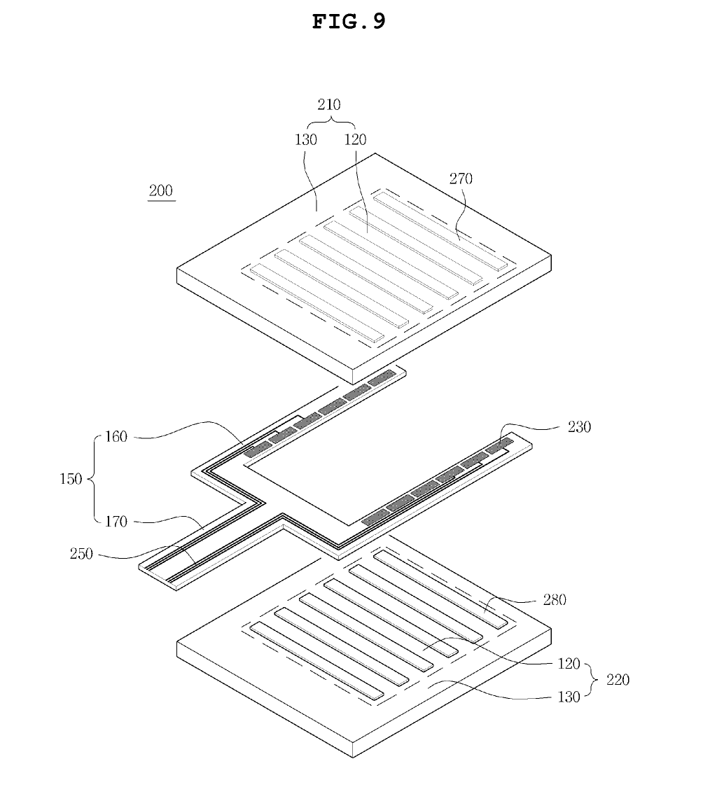

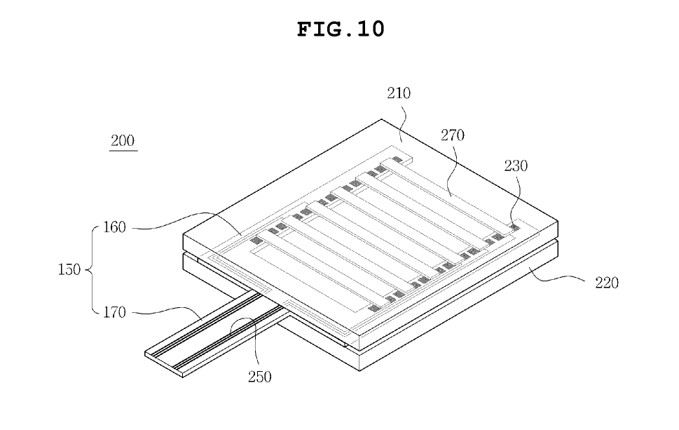

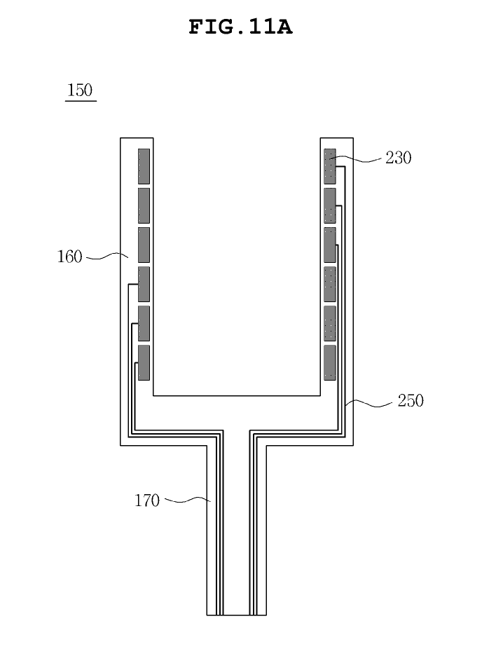

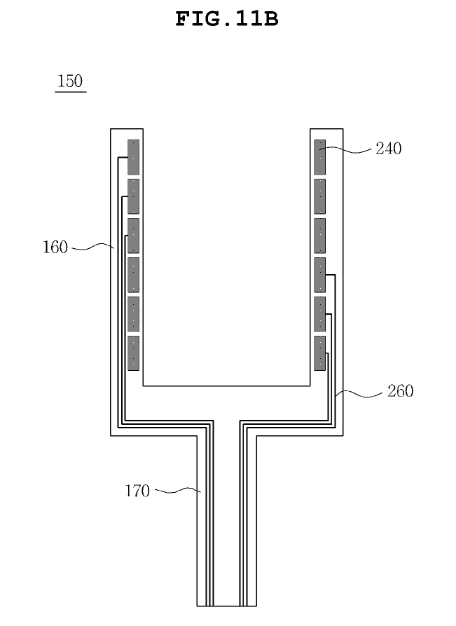

FIG. 9 is an exploded perspective view of a touch panel according to a second preferred embodiment of the present invention, FIG. 10 is a perspective view of a touch panel according to a second preferred embodiment of the present invention, FIG. 11A is a plan view of the flexible printed cable of FIG. 9, and FIG. 11B is a bottom view of the flexible printed cable of FIG. 9.

As shown in FIGS. 9 to 11, the most significant difference between the touch panel 200 according to the present embodiment and the touch panel 100 according to the first embodiment is the structure of the flexible printed cable and the number of the transparent substrates. In other words, in the touch panel 100 according to the first embodiment, the connection terminals 180 and the wirings 190 are formed on one surface of the flexible printed cable 150 and one transparent substrate 110 is provided. In contrast, in the touch panel 200 according to the present embodiment, connection terminals 230 and 240 and wirings 250 and 260 are formed on both surfaces of a flexible printed cable 150 and two transparent substrates (a first transparent substrate 210 and a second transparent substrate 220) are provided. Therefore, the present embodiment will be described focusing on the flexible printed cable 150 and the transparent substrates 210 and 220 and any description overlapping with that of the first embodiment will be omitted.

Each of the first transparent substrate 210 and the second transparent substrate 220 is configured to include an active region 120 and a connection region 130. At this time, one surface of a connection unit 160 of the flexible printed cable 150 is bonded to the connection region 130 of the first transparent substrate 210, and the other surface of the connection unit 160 of the flexible printed cable 150 is bonded to the connection region 130 of the second transparent substrate 220. Further, transparent electrodes 270 are formed in the active region 120 of the first transparent substrate 210 and second transparent electrodes 280 are formed in the active region 120 of the second transparent substrate 220.

The flexible printed cable 150 is configured to include the connection unit 160 and an extension unit 170, wherein first connection terminals 230 (see FIG. 11A) are formed on one surface of the connection unit 160 and second connection terminals 240 (see FIG. 11B) are formed on the other surface of the connection unit 160. Therefore, when one surface of the connection unit 160 is bonded to the connection region 130 of the first transparent substrate 210, the first connection terminals 230 are connected to the first transparent electrode 270, and when the other surface of the connection unit 160 is bonded to the connection region 130 of the second transparent substrate 220, the second connection terminals 240 are connected to the second transparent electrode 280 (see FIG. 10). Further, the flexible printed cable 150 is provided with the first wirings 250 that are extended from the first connection terminals 230 to be collected at the extension unit 170 and the second wirings 260 that are extended from the second connection terminals 240 to be collected at the extension unit 170, such that the signals generated from the transparent electrodes 270 and 280 are transferred to the wirings 250 and 260 through the connection terminals 230 and 240. Finally, the extension unit 170 is projected outward to the transparent substrates 210 and 220 to be connected to the controller, such that the signals generated from the first transparent electrodes 270 are transferred in the sequence, that is, the first connection terminals 230→the first wirings 250→the controller, and the signals generated from the second transparent electrodes 280 are transferred in the sequence, that is, the second connection terminals 240→the second wirings 260→the controller.

The touch panel 200 according to the present embodiment has a structure in which the first transparent electrodes 270 and the second transparent electrodes 280 are disposed in two-layers based on the flexible printed cable 150, such that it can be used as a resistive type touch panel. Alternatively, the touch panel 200 can be used as a mutual capacitive type touch panel by disposing an insulating layer between the first transparent electrodes 270 and the second transparent electrodes 280.

According to the present invention, the wirings are formed on the flexible printed cable, such that the process for connecting the flexible printed cable to the wirings can be omitted, different from the prior art, thereby making it possible to simplify the manufacturing process.

Further, according to the present invention, the flexible printed cable including the connection unit is directly connected to the transparent electrodes, such that the contact area between the flexible printed cable and the transparent substrate becomes wide, as compared to the prior art. Therefore, it is possible to prevent the flexible printed cable from being detached even if a force of more than a predetermined strength is applied.

Further, according to the present invention, the wirings are formed on the flexible printed cable rather than on the transparent substrate, different from the prior art, such that they can be made of metal. Therefore, it is possible to improve electric conductivity of the wirings and form fine wirings.

Although the embodiment of the present invention has been disclosed for illustrative purposes, it will be appreciated that a touch panel according to the invention is not limited thereby, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate that includes an active region and a connection region provided at the edges of the active region;
transparent electrodes that are formed in the active region;
a flexible printed cable that includes a connection unit formed corresponding to the connection region and having one surface bonded to the connection region and an extension unit extended from the connection unit and projected outward to the transparent substrate;
connection terminals that are formed on one surface of the connection unit so as to be connected to the transparent electrodes; and
wirings that are formed on the flexible printed cable so that the wirings are extended from the connection terminals to be collected at the extension unit.

2. The touch panel as set forth in claim 1, wherein the active region is formed in a rectangular shape and the connection unit is formed so as to correspond to the connection region provided at four edges of the active region.

3. The touch panel as set forth in claim 1, wherein the active region is formed in a rectangular shape and the connection unit is formed so as to correspond to the connection region provided at three edges of the active region.

4. The touch panel as set forth in claim 1, wherein the active region is formed in a rectangular shape and the connection unit is formed so as to correspond to the connection region provided at two continuous edges of the active region.

5. The touch panel as set forth in claim 1, wherein the active region is formed in a rectangular shape and the connection unit is formed so as to correspond to the connection region provided at one edge of the active region.

6. The touch panel as set forth in claim 1, wherein one or two extension unit is provided.

7. The touch panel as set forth in claim 1, wherein the connection terminal is connected to the transparent electrode using an anisotropic conductive adhesive or an anisotropic conductive film.

8. The touch panel as set forth in claim 1, wherein the transparent electrode is made of a conductive polymer.

9. A touch panel, comprising:
first and second transparent substrates that include an active region and a connection region provided at the edges of the active region;
first transparent electrodes that are formed in the active region of the first transparent substrate;
second transparent electrodes that are formed in the active region of the second transparent substrate;
a flexible printed cable that includes a connection unit formed corresponding to the connection region and having one surface bonded to the connection region of the first transparent substrate and the other surface bonded to the connection region of the second transparent substrate and an extension unit extended from the connection unit and projected outward to the first and second transparent substrates;
first connection terminal that are formed on one surface of the connection unit so as to be connected to the first transparent electrodes;
second connection terminals that are formed on the other surface of the connection unit so as to be connected to the second transparent electrodes;
first wirings that are formed on the flexible printed cable so that the first wirings are extended from the first connection terminal to be collected at the extension unit; and
second wirings that are formed on the flexible printed cable so that the second wirings are extended from the second connection terminal to be collected at the extension unit.

10. The touch panel as set forth in claim 9, wherein the active region is formed in a rectangular shape and the connection unit is formed so as to correspond to the connection region provided at four edges of the active region.

11. The touch panel as set forth in claim 9, wherein the active region is formed in a rectangular shape and the connection unit is formed so as to correspond to the connection region provided at three edges of the active region.

12. The touch panel as set forth in claim 9, wherein the active region is formed in a rectangular shape and the connection unit is formed so as to correspond to the connection region provided at two continuous edges of the active region.

13. The touch panel as set forth in claim 9, wherein the active region is formed in a rectangular shape and the connection unit is formed so as to correspond to the connection region provided at one edge of the active region.

14. The touch panel as set forth in claim 9, wherein one or two extension unit is provided.

15. The touch panel as set forth in claim 9, wherein the first connection terminal is connected to the first transparent electrode using an anisotropic conductive adhesive or an anisotropic conductive film and the second connection terminal is connected to the second transparent electrode using an anisotropic conductive adhesive or an anisotropic conductive film.

16. The touch panel as set forth in claim 9, wherein the first transparent electrode or the second transparent electrode is made of a conductive polymer.
